(19) United States
(12) Patent Application Publication
(10) Pub. No.: US 2016/0275469 A1
(43) Pub. Date: Sep. 22, 2016

(54) SYSTEMS AND METHODS FOR PROVIDING INFORMATION TECHNOLOGY ON AN AS-USED BASIS

(71) Applicant: Winthrop Resources Corporation, Minnetonka, MN (US)

(72) Inventor: Paul L. Gendler, Minnetonka, MN (US)

(21) Appl. No.: 15/074,230

(22) Filed: Mar. 18, 2016

Related U.S. Application Data
(60) Provisional application No. 62/136,032, filed on Mar. 20, 2015.

(51) Int. Cl. G06Q 20/14; H04L 29/08

(52) U.S. Cl. CPC G06Q 20/145; H04L 67/22

(57) ABSTRACT

Systems and methods for providing use of information technology in exchange for a fee based more precisely on actual or near actual use. Information technology may include software and/or hardware, which may be grouped into a convergent infrastructure or convergent architecture. Use of the hardware and/or software may be monitored, such as with metering software, by measuring usage metrics to determine resource usage. The raw metrics data may be converted into at least one common unit of measure. The raw or converted metrics may be used to determine a fee based on resource usage. The fee may be based on a fee rate, determined or calculated with reference to various information such as the type of information technology being used. The user may be charged the fee based on actual past usage, an approximation of past usage, an estimation of future usage, or a different usage basis.

### CROSS-REFERENCE TO RELATED APPLICATIONS

This application claims the benefit of U.S. Provisional Patent Application No. 62/136,032, filed on Mar. 20, 2015, entitled “SYSTEMS AND METHODS FOR PROVIDING INFORMATION TECHNOLOGY ON AN AS-USED BASIS,” the disclosure of which is hereby incorporated by reference herein in its entirety.

### FIELD OF THE INVENTION

The present disclosure relates to systems and methods for providing information technology to a user. Particularly, the present disclosure relates to providing information technology, such as hardware and software, to a user, in exchange for a fee that is based more precisely on the user's usage of the hardware and software.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In various situations, a user may have a need for information technology, which may generally include, but is not limited to, computer and networking hardware and/or software. For example, a user may require a level of computer processing power, computer data storage, network access, virtualization, or other information technology. A user may acquire information technology in various conventional ways. For example, a user may purchase computer and/or networking hardware and/or software. Where a user desires computer data storage capabilities, for instance, the user may purchase a data storage device such as a solid state or disk storage device. Purchase of the device may provide the user with a finite amount of storage in exchange for a fixed sale price. In such a purchase situation, if the user's data storage needs increase or decrease in the future, the user may be faced with the need to acquire more storage or maintain more storage space than is necessary. As another way of acquiring information technology, a user may rent or lease hardware and/or software. For example, when a user desires computer data storage capabilities, the user may rent or lease storage space, for example solid state or disk storage space, from a provider. The rented or leased space may be available locally or remotely. In some cases, the leased or rented storage space may be available over a network, such as a cloud-based network. A user may pay a fixed price for predetermined blocks, for example ten-gigabyte blocks, of data storage space. In this way, the user may be able to add or remove blocks of storage space as the user's storage demands change. However, a user may be faced with paying for an additional block of space, where only a small fraction of the additional storage block is needed. Conversely, when a user has leased only a certain amount of block space but later needs additional space, the user may have to wait until a new lease period begins to add additional space. Similar situations may arise where a user requires various other information technology components, such as processors or servers, and where the user may be required to purchase, lease, or rent predetermined blocks or amounts of such hardware.

Thus, there is a need in the art for systems and methods for providing information technology where, in exchange for such information technology, a user pays a fee based more precisely on the user's usage, or actual usage, of the information technology resources.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for providing use of information technology in exchange for a fee based on actual or near actual use or one or more estimates of usage that are more precise indicator(s) of actual or near actual use. Information technology may include software and/or hardware, which may be grouped into a convergent infrastructure or convergent architecture. Use of the hardware and/or software may be monitored, such as with metering software. The metering software or other monitoring means may measure usage metrics to determine resource usage. The raw metrics data may be converted into at least one common unit of measure. The raw or converted metrics may be used to determine a fee based on resource usage of the information technology. The fee may be based on a fee rate, determined or calculated with reference to various information such as the type and amount of information technology being used. The user may be charged the fee based on actual past usage, an approximation of past usage, an estimation of future usage, or a different usage basis.

The present disclosure, in another embodiment, relates to a method for providing use of information technology to a user in exchange for a fee. The method may include providing information technology having at least one computer or network hardware component to the user, monitoring the user's actual usage of the information technology, determining a fee rate for the information technology, and charging a fee to the user, wherein the fee is based on the monitored usage and the fee rate. In some embodiments, the information technology may be a combination of computer or network hardware components and software operating in an independent unit of converged infrastructure. In still further embodiments, there may be a plurality of independent units of converged infrastructure. At least two of the units of converged infrastructure may vary in at least one of the components included in the unit and the configuration thereof. In some embodiments, determining a fee rate for the information technology may include determining a fee rate for each of a plurality of units of converged infrastructure. At least two of the plurality of units of converged infrastructure could have a different fee rate. Monitoring the user's actual usage of the information technology may include using metering software, wherein the metering software monitors at least one usage metric of the information technology. The at least one usage metric may be converted into a normalized unit(s). Where the metering software monitors a plurality of usage metrics of the information technology of varying units of measurement, each usage metric may be converted into the normalized unit(s). In some embodiments, the normalized unit(s) is a Workload Allocation Cube. In some embodiments, the normalized unit(s) may be weighted. The normalized unit(s) of each usage metric may be weighted, for example, based on but not limited to size, capacity, performance, cost, age, or importance of the information technology corresponding with that usage metric in relative comparison to the information technology corresponding to the remaining usage metrics. In some embodiments, determining a fee rate for the information technology may include determining a fee rate for each of a plurality of hardware or hardware/software components. The fee charged to the user may be based on a combination of the fee rate for each of the plurality of hardware or hardware/software components and the monitored usages of the corresponding hardware or hardware/software components. In some cases, the fee charged to the user may be for past usage of the information technology. While in some other cases, the fee charged to the user may be for a predicted future usage of the information technology based on the past usage of the information technology.

The present disclosure, in yet another embodiment, relates to a system of information technology having a fee more accurately based on actual usage thereof. The system may include information technology having at least one computer or network hardware component and monitoring software operably communicating with the information technology and monitoring actual usage of the information technology. A fee may be associated with the information technology and chargeable to a user of the information technology, wherein the fee is based on a combination of the monitored usage and a fee rate associated with the information technology. In some embodiments, the information technology includes a combination of computer or network hardware components and software operating in a plurality of independent units of converged infrastructure and the fee rate associated with the information technology includes a fee rate for each of the plurality of units of converged infrastructure. In further embodiments, the monitoring software monitors a plurality of usage metrics of the information technology of varying units of measurement and each usage metric is converted into a normalized unit(s) and wherein the fee associated with the information technology is based on a combination of the fee rate for each of the plurality of hardware or hardware/software components and the normalized unit(s) of usage of the corresponding hardware or hardware/software components.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figure, in which:

FIG. 1 is a flowchart showing one embodiment of a method of the present disclosure.

### DETAILED DESCRIPTION

The present disclosure relates to systems and methods for providing information technology on a more precise as-used basis. In general, hardware and/or software may be provided to or acquired by a user, and the user's resource usage of the hardware and/or software may be monitored. The user may be charged a fee, such as a rental or lease rate, for the information technology based on the user's actual resource usage or a near approximation of resource usage of the hardware and/or software.

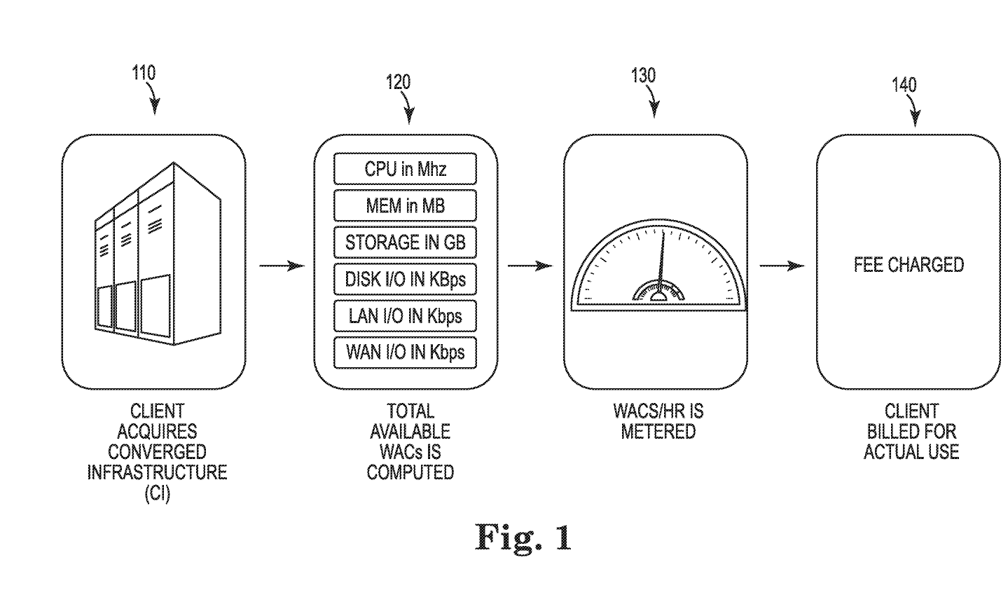

FIG. 1 generally illustrates one embodiment of a method of the present disclosure. At a general level, as shown in FIG. 1, a user may acquire or be provided with information technology, such as a grouping of hardware and/or software for example. (110) A user may be one or more individuals, one or more businesses, or one or more other entities, or combinations thereof. The user's use of the hardware and/or software grouping may be monitored. (120) Monitoring use of the hardware and/or software grouping may include measures of the amount of processing power utilized, amount of storage utilized, or other metrics for measuring usage of the information technology. For example, the number of hertz, kilohertz, or megahertz, etc. used by the central processing unit may be monitored. As another example, the local area network input/output (I/O) may be measured in, for example, bytes or kilobytes per second. The varying metrics that are monitored may be monitored in varying units such as hertz and bytes or any other suitable unit. The differing units may be converted into one or more common units that may be combined to determine an overall usage value. (130) In some embodiments, the metrics may be converted into and totaled as Workload Allocation Cubes (WACs), described in more detail below. WACs may be measured or totaled over a period of time. For example, a number of WACs per hour may be totaled, or WACs may be measured or totaled over any other period of time. Based on the determined usage, the user may be billed a certain fee, calculated from the usage metrics. (140) The fee based on usage may reflect actual use over a prior period, a close approximation of use over a prior period, or may be an approximation of future use based on past use.

With more specific reference to step 110 in FIG. 1, according to systems and methods of the present disclosure, information technology may be provided to or acquired by a user in the form of hardware and/or software resources. Hardware may include, but is not limited to, data storage devices or data storage subsystems, routers, hubs, other network devices or components, processing chips, microprocessing chips, central processing units (CPUs), servers or server racks, desktop computers, notebook computers, tablet computers, or other similar computer or telecommunications hardware components. Hardware may also include such peripheral components as monitors, digital displays, printers keyboards, computer mice, or other peripheral or secondary components. Software may be various systems software or application software. Systems software may include such programs as operating systems, file management utilities, or disk operating systems, for example. Application software may include virtualization software, allowing for the running of virtual machines, for example. Other types of software may also be provided to a user according to additional embodiments.

With reference still to step 110 of FIG. 1, according to some embodiments, information technology may be provided to or acquired by a user in the form of a hardware and software grouping. The grouping of hardware and software may be referred to herein as a converged infrastructure or converged architecture device. In some embodiments, a converged infrastructure or converged architecture device may include various hardware and/or software resources, such as, but not limited to, some or all of those described above. A converged infrastructure or converged architecture device may be a combination of hardware and/or software that functions together as a computing system. A converged infrastructure or converged architecture device may, in some embodiments, be combined to function as a general computing system capable of performing various tasks, such as a personal computer. In other embodiments, a converged infrastructure or converged architecture device may be combined to function as an enterprise computing and data storage system capable of performing tasks for a plurality of users, often simultaneously. In still other embodiments, a converged infrastructure or converged architecture device may have hardware and/or software components combined to form a computing system capable of performing only limited tasks or designed with a particular purpose(s) in mind. One non-limiting example of a converged infrastructure or converged architecture device may be a VBlock™ system provided by Virtual Computing Environment Company (VCE), headquartered in Richardson, Tex. However, other converged infrastructure or converged architecture devices provided by other manufacturers or providers may be used additionally or alternatively.

A converged infrastructure or converged architecture device may have varying configurations of hardware and/or software. In some embodiments, a user may select a pre-defined configuration of hardware and/or software. The pre-defined configurations may be available in various sizes, with for example, differing storage capacities, networking capabilities, processing power, and/or included software. In some embodiments, a user may select or customize software and/or hardware components to be grouped in a converged infrastructure or converged architecture device. For example, in some embodiments, a user may have the opportunity to “build” a device based on the user's individual software and hardware needs. In some embodiments, a user may desire only software or only hardware or a limited variety of both software and hardware. For example, in some embodiments, a user may desire only computer data storage, for example to add onto an already existing system, and may not desire additional hardware or software. In such a case, the user may be provided with or may acquire the data storage that the user needs, without the need for an entire grouping of software and hardware.

An example of a storage device that may be included in a converged infrastructure or converged architecture device may be a data storage device or system of data storage devices manufactured by EMC Corp., headquartered in Hopkinton, Mass. An example of a network device that may be included in a converged infrastructure or converged architecture device may be a network device or combination of network devices manufactured by Cisco Systems, headquartered in San Jose, Calif. An example of a processing chip or microprocessor that may be included in a converged infrastructure or converged architecture device may be a processing chip or microprocessor or combination of processing chips, microprocessors, or CPUs manufactured by Intel Corp., headquartered in Santa Clara, Calif. An example of an operating system or other systems software that may be included in a converged infrastructure or converged architecture device may be an operating system provided by Microsoft Corp., headquartered in Redmond, Wash. An example of virtualization software that may be included in a converged infrastructure or converged architecture device may be vSphere™ provided by VMware, headquartered in Palo Alto, Calif. Other types and designs of hardware and software, provided by other manufacturers or retailers in any combination and/or quantities, may be used in addition to or in alternative to the above examples.

With specific reference now to step 120, according to some embodiments, metering software may be provided to monitor resource usage of the information technology provided in step 110. Generally, metering software may track use of hardware and/or software by any suitable method. For example, metering software may track certain metrics during use of computer or networking hardware and software in order to determine or estimate a quantity of resource usage. Metering software may track, for example, such metrics as CPU usage, memory usage, local area and wide area network I/O, disk I/O, and/or any other suitable metrics. Each metric may be measured in conventionally corresponding units. For example, CPU usage may be measured in hertz, kilohertz, or megahertz, memory usage may be measured in bytes, kilobytes, megabytes, or gigabytes, and I/O may be measured in bytes, kilobytes, or megabytes per second. Of course, other unit measures may be used. As one example of varying units, in a converged infrastructure or converged architecture having a large amount of data storage space, storage space used may be measured in terabytes. In one embodiment, metering software may be metering software provided by 6 fusion USA, Inc., headquartered in Raleigh, N.C., for example. However, additionally or alternatively, other metering software or applications may be used. In some embodiments, metering software may be provided to a user in conjunction with any hardware and/or software of step 110. For example, metering software may be installed on one or more pieces or combinations of hardware before the converged infrastructure or converged architecture device is provided to the user, or may be installed on one or more pieces or combinations of hardware after the converged infrastructure or converged architecture device is provided to the user. Metering software may require user purchase and/or installation in other embodiments. In some embodiments, metering software may be a type of software as a service (SaaS). According to different embodiments, metering software may monitor a user's resource usage locally or remotely, such as via a network connection such as the Internet.

To better compare the measured metrics, metrics measurements determined by metering software may be converted into at least one common unit of measure. According to some embodiments, a common unit of measure may be a unit that is unique from the measured metrics units. Specifically, each measured metric may be manipulated by way of one or more equations to convert or normalize the metric into a common unit such that the individual metrics may be totaled or otherwise compared to one another. Workload Allocation Cube units (WACs), as described in U.S. Pat. No. 8,756,302, incorporated in its entirety herein by reference, are one example of a common unit into which individual metrics may be converted. Other common units of measure for comparing various metrics of different units may additionally or alternatively be used in some embodiments. Conversion into a common unit of measure may allow for a better overall comparative view of resource usage of the convergent infrastructure or convergent architecture as a whole. The individual equations used to convert each metric into WACs or another common unit may be calculated to weigh the metric appropriately in comparison with other metrics. Conversion equations may also take into account the size, capacity, performance, or importance of the component that each metric is measuring in relative comparison with the entire converged infrastructure or converged architecture as provided to or acquired by the user. In some embodiments, once each measured metric is converted into a common unit of measure, such as a WAC, the metrics may be combined in various ways so as to better determine or estimate a user's overall usage of the hardware and/or software. Combining the converted metrics may include merely adding the individual metrics together in their common unit form, or may involve various other operations such as multiplying the individual metrics by weighted percentages or other mathematical or algorithmic operations. Conversion of the metrics data into one or more common units may be performed by the metering software, or alternatively may be performed with the use of different software or in some cases, at least in part, by a human being.

With specific reference now to step 130 of FIG. 1, metrics may generally be measured over a period of time so as to determine or estimate a user's resource usage over a certain period of time. In some embodiments, metrics may be measured in the form of a common unit, such as WACs, over a period of time. The metrics may be tracked or measured as WACs or any other unit(s) over a period of a second, minute, hour, day, week, month, or any other period of time. As one example, one or more metrics may be tracked or measured in WACs per hour. In still further embodiments, metrics over a relatively longer period of time may be expressed as an average of the metrics over multiple subset periods of time. For example, metrics measured over a period of a month may be expressed as an average of the daily measured metrics during that month, or the like. In some embodiments, the metering software may track metric measurements over a period of time. In other additional or alternative embodiments, metrics data, whether in a common unit form or not, may be tracked or measured over a time period by other software and/or, at least in part, by a human being. In some embodiments, the measurement of one or more metrics over a time period, which provides a determination or estimation of a user's usage of the information technology, may be incorporated in calculation of a fee billed to the user.

With specific reference now to step 140 of FIG. 1, a user may be billed or otherwise required to pay a certain fee, such as a rental fee or lease fee in exchange for use of information technology such as a converged infrastructure or converged architecture device of FIG. 1. In some embodiments, the fee may be calculated or derived using a fee rate. The fee rate for any given user may be determined or calculated, for example using one or more equations or algorithms, based on various data, such as but not limited to, the size or capacity of the information technology being provided to that user, the cost of the information technology being provided to that user, the age of the information technology being provided to that user, the type of information technology being provided to that user, the anticipated amount of use by that user, the number of subusers of the information technology being provided to that user, the type of entity of that user, the manner of use by that user, and/or any other suitable information. The fee rate may of course be different for each of multiple users/entities. In further embodiments, a different fee rate may be calculated for different hardware or software components used or for different groupings of hardware or software within the same user's convergent infrastructure or convergent architecture device. Additionally, the fee rate could be calculated based on maximum or minimum possible usage of the system, such as for example a maximum number of WACs that may be used over a measurement period.

With specific reference still to step 140 of FIG. 1, once a fee rate is determined, the fee rate may be used to calculate or determine a fee that may be billed to the user or that the user may otherwise be required to pay. The fee may be based, at least in part, on data gathered from metering software. The fee may be based on individually measured metrics and/or converted data in the form of a common unit, such as WACs. One or more equations may be used to determine a fee based on metrics data. The fee may be calculated based on actual use over a period of time, an approximation of use over a period of time, an average use over a period of time, and/or an estimation of future use. In some embodiments, the fee for a given period of time may be calculated by simply multiplying a user's fee rate by the user's actual or estimated usage of the information technology, for example the measured WACs, over that period of time. In other embodiments, different mathematical or algorithmic may be used to determine a fee based on a user's fee rate and the user's actual or estimated usage over a specified period of time. Other data may additionally or alternatively be incorporated in the determination or calculation of a user's fee such as, for example, specifics about the information technology being used, the user, the type of usage, and/or other data. The fee may be calculated on an hourly, daily, weekly, monthly, bimonthly, annual, or other period.

The systems and methods of the present disclosure may provide users with information technology that meets their needs without the expense of a purchase price or fixed rental rate. According to embodiments of the present disclosure, a system administrator may assist a user in selecting hardware and/or software or with building or selecting a converged infrastructure or converged architecture device. In some embodiments, a user may acquire information technology by other means. As the user makes use of the hardware and/or software, resource usage metrics may be measured, for example by metering software. In some embodiments, the raw metrics data may be sent to the system administrator on a continuous, daily, weekly, monthly, bimonthly, annually, or other basis. The system administrator may calculate or determine a fee rate, based on various information as discussed above, such as the type of information technology being used. The system administrator may calculate a fee based on the raw metrics data and/or the determined or calculated fee rate. The system administrator may, according to some embodiments, convert the raw metrics data into a common unit of measure. In other embodiments, the metering software may convert the raw metrics data into a common unit of measure prior to sending the data to the system administrator. The system administrator may incorporate other data into calculation of a fee, as discussed above. The fee may be charged to the user on a daily, weekly, monthly, bimonthly, annually, or other basis. The fee charged to the user may more precisely reflect the user's actual use of the information technology for a prior billing or measuring period, such that the user more precisely pays for prior actual usage of the information technology. In some embodiments, the metrics data, whether or not converted into a common unit of measure, may be used to project an estimation of future use of the information technology. In that case, a user may be charged a fee based on an estimation of future use. In some embodiments, a minimum or maximum fee may be determined, such that a user may be charged at least the determined minimum rate and no more than the determined maximum rate.

The systems and methods of the present disclosure are advantageous over conventional means for supplying information technology to a user because the systems and methods of the present disclosure allow a user to pay for hardware and/or software based more precisely on actual use, rather than paying a purchase price, a fixed rental rate, or an arbitrary estimated usage rate. In this way, a user may avoid paying for too much or too little for its information technology, and a business user may avoid an upfront purchase price of information technology. Users may instead acquire any suitable amount of information technology desired while paying more precisely for what they actually use, or at least a more realistic approximation of what they actually use. In addition, the systems and methods of the present disclosure may provide a level of security over cloud-based or remotely located information technology because the as-used lease basis may allow for the information technology to be more securely located on the user's premises.

In addition, systems and methods of the present disclosure may allow a user to modify an existing convergent infrastructure or convergent architecture device. A user may add, remove, or rearrange hardware or software from an existing device. As an example, a user may wish to add additional storage space onto an existing convergent infrastructure or convergent architecture device. This may be accomplished by adding RAID or other storage disks or devices, externally or internally, onto the existing system. Adding hardware or software to an existing device may increase the user's fee rate. Conversely, removing hardware or software from an existing device may decrease the user's fee rate.

While generally described above with respect to certain examples, it is understood that for purposes of this disclosure, any system such as the convergent infrastructure or convergent architecture described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a CPU or hardware or software control logic, read-only memory (ROM), and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various I/O devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in and/or include a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, such as the convergent infrastructure or convergent architecture, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, RAM, ROM, an erasable programmable read-only memory (EPROM or Flash memory), a CD-ROM, or other optical or magnetic storage device. Computer-readable media includes, but is not to be confused with, computer-readable storage medium, which is intended to cover all physical, non-transitory, or similar embodiments of computer-readable media.

Various embodiments of the present disclosure are described herein with reference to a flowchart illustration and/or block diagram of methods, apparatus (systems), and computer program products. It is understood that certain blocks of the flowchart illustration and/or block diagram, and/or combinations of blocks in the flowchart illustration and/or block diagram, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart or block diagram illustrated herein can be performed in parallel or concurrently, and the flowchart or block diagram should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for providing use of information technology to a user in exchange for a fee, the method comprising:
providing information technology comprising at least one computer or network hardware component to the user;
monitoring the user's actual usage of the information technology;
determining a fee rate for the information technology; and
charging a fee to the user, the fee based on a combination of the monitored usage and the fee rate.

2. The method of claim 1, wherein the information technology comprises a combination of computer or network hardware components and software operating in an independent unit of converged infrastructure.

3. The method of claim 2, wherein the information technology comprises a combination of computer or network hardware components and software operating in a plurality of independent units of converged infrastructure.

4. The method of claim 3, wherein at least two of the plurality of units of converged infrastructure vary in at least one of the components included in the unit and the configuration thereof.

5. The method of claim 4, wherein determining a fee rate for the information technology comprises determining a fee rate for each of a plurality of units of converged infrastructure.

6. The method of claim 5, wherein at least two of the plurality of units of converged infrastructure have a different fee rate.

7. The method of claim 1, wherein monitoring the user's actual usage of the information technology comprises providing metering software, the metering software monitoring at least one usage metric of the information technology.

8. The method of claim 7, wherein the at least one usage metric is converted into a normalized unit(s).

9. The method of claim 8, wherein the metering software monitors a plurality of usage metrics of the information technology of varying units of measurement and each usage metric is converted into the normalized unit(s).

10. The method of claim 8, wherein the normalized unit(s) is a Workload Allocation Cube.

11. The method of claim 9, wherein the normalized unit(s) is a Workload Allocation Cube.

12. The method of claim 8, wherein the metering software monitors a plurality of usage metrics of the information technology of varying units of measurement and each usage metric is converted into a weighted normalized unit(s).

13. The method of claim 12, wherein the normalized unit(s) of each usage metric are weighted based on at least one of a size, capacity, performance, cost, age, or importance of the information technology corresponding with that usage metric in relative comparison to the information technology corresponding to the remaining usage metrics.

14. The method of claim 1, wherein determining a fee rate for the information technology comprises determining a fee rate for each of a plurality of hardware or hardware/software components.

15. The method of claim 14, wherein the fee charged to the user is based on a combination of the fee rate for each of the plurality of hardware or hardware/software components and the monitored usages of the corresponding hardware or hardware/software components.

16. The method of claim 1, wherein the fee charged to the user is for past usage of the information technology.

17. The method of claim 1, wherein the fee charged to the user is for a predicted future usage of the information technology based on a past usage of the information technology.

18. A system of information technology having a fee more accurately based on actual usage thereof, the system comprising:
information technology comprising at least one computer or network hardware component;
monitoring software operably communicating with the information technology and monitoring actual usage of the information technology; and
a fee associated with the information technology and chargeable to a user of the information technology, the fee based on a combination of the monitored usage and a fee rate associated with the information technology.

19. The system of claim 18, wherein the information technology comprises a combination of computer or network hardware components and software operating in a plurality of independent units of converged infrastructure and wherein the fee rate associated with the information technology comprises a fee rate for each of the plurality of units of converged infrastructure.

20. The system of claim 19, wherein the monitoring software monitors a plurality of usage metrics of the information technology of varying units of measurement and each usage metric is converted into a normalized unit(s) and wherein the fee associated with the information technology is based on a combination of the fee rate for each of the plurality of hardware or hardware/software components and the normalized unit(s) of usage of the corresponding hardware or hardware/software components.
